(19) United States
(12) Patent Application Publication
(10) Pub. No.: US 2020/0013077 A1
(43) Pub. Date: Jan. 9, 2020

(54) SYSTEM AND METHOD FOR CUSTOMER FEEDBACK PROCESSING

(71) Applicant: Walmart Apollo, LLC, Bentonville, AR (US)

(72) Inventor: Mani Kanteswara Rao Garlapati, Bangalore (IN)

(21) Appl. No.: 16/453,404

(22) Filed: Jun. 26, 2019

Related U.S. Application Data
(60) Provisional application No. 62/723,746, filed on Aug. 28, 2018.

(30) Foreign Application Priority Data
Jul. 3, 2018 (IN) 201841024768

(51) Int. Cl. G06Q 30/02; G06F 16/951; G06F 17/27

(52) U.S. Cl. CPC G06Q 30/0203; G06F 17/2775; G06F 16/951

(57) ABSTRACT

Customers submit reports to a reporting center. Topic sentences are identified. For each of a plurality of values of k, a separate k-grouping matrix is created from a master matrix by the control circuit. Each k-grouping matrix arranges the topic sentences into k groupings based upon the similarity of words as between different topic sentences. Each of the k-grouping matrices is created at least in part by moving or rearranging some of the rows of the master matrix. The most frequent topic sentences are identified and used to identify an action.

### CROSS-REFERENCE TO RELATED APPLICATIONS

This application claims the benefit of the following: Indian Provisional Application No. 201841024768 filed Jul. 3, 2018 and U.S. Provisional Application No. 62/723,746 filed Aug. 28, 2018, both of which are incorporated herein by reference in their entireties.

### TECHNICAL FIELD

These teachings relate to the processing of customer feedback reports and taking actions based upon an analysis of these reports.

### BACKGROUND

Customer feedback is often used to improve products and also improve the purchasing experience of customers in retail store, online, or elsewhere. There are various ways for a customer to offer feedback. For example, the customer may phone a call center and describe their issue of concern. In another example, the customer may send an email or text message with their concerns to a central email address or central processing center.

In many situations, large amounts of consumer reports are received. For example, with larger chain stores, thousands of complaints are received every day. Some current approaches rely upon manual review and sorting of the data. Such approaches are time-consuming and often mistake-prone. Because of the time-consuming nature of these previous approaches, actions that alleviate the problems identified by the customers can be delayed, and overall customer service suffers as a result.

### BRIEF DESCRIPTION OF THE DRAWINGS

The above needs are at least partially met through the provision of approaches that process customer reports, wherein:

FIG. 1 comprises a diagram of a system as configured in accordance with various embodiments of these teachings;

FIG. 2 comprises a flowchart as configured in accordance with various embodiments of these teachings;

FIG. 3 comprises a diagram as configured in accordance with various embodiments of these teachings;

FIG. 4 comprises a diagram as configured in accordance with various embodiments of these teachings;

FIG. 5 comprises a diagram as configured in accordance with various embodiments of these teachings;

FIGS. 6A-F comprises a diagram as configured in accordance with various embodiments of these teachings;

FIG. 7 comprises a diagram as configured in accordance with various embodiments of these teachings.

### DETAILED DESCRIPTION

Generally speaking, an automated data entry device (such as a smart-bot) receives customer reports and these reports may be associated with an issue category such as a complaint. Topic sentences are determined from the reports and the topic sentences (along with their frequency) are stored in a master matrix. With k being an integer and for multiple values of k, the k matrices are created. In each of the k matrices, k groupings of topic sentences are made. The groupings are based upon the similarity of words in corresponding topic sentences. Then, the k matrix with the highest value of k is selected that has no duplicate entries. This matrix will have k groupings of topic sentences. Each of these k-groupings has a most-frequently occurring topic sentence. These k most frequent topic sentences are selected and can be mapped to an issue category. Once the issue category is determined, the issue can be addressed by the performance of some action.

In many of these embodiments, a system that is configured to determine and take actions based upon consumer reports includes an automated vehicle, a plurality of user electronic devices, a communication network, a smart-bot (or some other automated data entry device), a database, and a control circuit.

The automated vehicle is disposed in a retail store. The plurality of user electronic devices are operated by customers. Each of the user electronic devices comprises an electronic interface that is configured to receive consumer reports from a customer. The communication network is coupled to the user electronic devices.

The smart-bot is disposed at a central processing center and is configured to receive and automatically discern the customer reports from the user electronic devices using natural language processing approaches. The received reports are automatically tagged by the smart-bot with issue categories selected from an issue category list. The smart-bot is configured to web-scrape a plurality of web sites via the communication network to collect issue categories from the web sites, and add to or adjust to the issue category list based upon the obtained web-scraped issue categories. The smart-bot is configured to utilize the natural language processing approaches to determine when the consumer reports are missing information, and when the consumer reports are missing information, responsively transmit a first electronic message to one of the user electronic devices for rendering at the electronic interface of the user electronic device. The first electronic message requests the consumer enter the missing information into the first electronic interface.

The database disposed at a central processing center. The database stores the issue category list.

The control circuit is coupled to the data entry device and the database and is disposed at the central processing center. The control circuit is configured to determine a plurality of topic sentences and the frequency of the topic sentences from the received reports. The control circuit is additionally configured to construct a master matrix and store the master matrix in the database. The master matrix comprises a plurality of rows with each row including one of the topic sentences and the frequency of the topic sentence.

For each of a plurality of values of k, a separate k-grouping matrix is created from the master matrix by the control circuit. Each k-grouping matrix arranges the topic sentences into k groupings based upon the similarity of words as between different topic sentences. Each of the k-grouping matrices is created at least in part by moving or rearranging some of the rows of the master matrix.

The k-grouping matrix having the highest value of k that does not include duplicate topic sentences is selected by the control circuit. From the selected k-grouping matrix, the control circuit selects the most frequent topic sentences from each of the k groupings within the k-grouping matrix.

The control circuit maps each of the selected most frequent k topic sentences to one of the issue categories. Based upon each mapped issue category, the control circuit automatically determines one or more actions to be undertaken at the retail store, by communications with the customer, or in the supply chain.

The action is performed by the automated vehicle or the smart-bot. The action is one or more of transmitting a second electronic message to one of the electronic devices, moving a product to the store or within the store, or moving the product through the supply chain. Other examples are possible.

In aspects, the control circuit automatically cleans the reports. For instance, typographic errors may be corrected. Other examples of cleaning are possible.

In other aspects, the user device comprises a smartphone, a laptop, a tablet, or a personal computer. Other examples are possible.

In examples, the issue category is a complaint, an inquiry, or an observation. Other examples are possible.

In other examples, the automated vehicle is a drone or automated ground vehicle. Other examples are possible.

In other aspects, the web sites include consumer survey reports. The web sites may include other information as well. The web-scraping may be performed across a single or multiple web sites.

In others of these embodiments, an automated vehicle is disposed in a retail store. A plurality of user electronic devices are operated by customers. Each of the user electronic devices comprises an electronic interface that is configured to receive consumer reports from a customer.

A smart-bot is disposed at a central processing center. The smart-bot is configured to receive and automatically discern the customer reports from the user electronic devices using natural language processing approaches. The received reports are automatically tagged by the smart-bot with issue categories selected from an issue category list. The smart-bot is configured to web-scrape a plurality of web sites via an electronic communication network to collect issue categories from the web sites, and add to or adjust to the issue category list based upon the obtained web-scraped issue categories.

The natural language processing approaches are utilized at the smart-bot to determine when the consumer reports are missing information. When the consumer reports are missing information, a first electronic message is responsively transmitted to one of the user electronic devices for rendering at the electronic interface of the user electronic device. The first electronic message requests the consumer enter the missing information into the first electronic interface. The issue category list is stored at a database.

At a control circuit at the central processing center, a plurality of topic sentences and the frequency of the topic sentences from the received reports are determined. At the control circuit, a master matrix is constructed, and the master matrix is stored in the database. The master matrix comprises a plurality of rows with each row including one of the topic sentences and the frequency of the topic sentence.

At the control circuit and for each of a plurality of values of k, a separate k-grouping matrix is created from the master matrix. Each k-grouping matrix arranges the topic sentences into k groupings based upon the similarity of words as between different topic sentences. Each of the k-grouping matrices is created at least in part by moving or rearranging some of the rows of the master matrix.

At the control circuit, the k-grouping matrix having the highest value of k that does not include duplicate topic sentences is selected. At the control circuit and from the selected k-grouping matrix, the most frequent topic sentences from each of the k groupings within the k-grouping matrix are selected.

At the control circuit, each of the selected most frequent k topic sentences is mapped to one of the issue categories. At the control circuit and based upon each mapped issue category, one or more actions to be undertaken at the retail store, by communications with the customer, or in the supply chain are automatically determined.

The action is performed by the automated vehicle or the smart-bot. In aspects, the action is one or more of transmitting a second electronic message to one of the electronic devices, moving a product to the store or within the store, or moving the product through the supply chain.

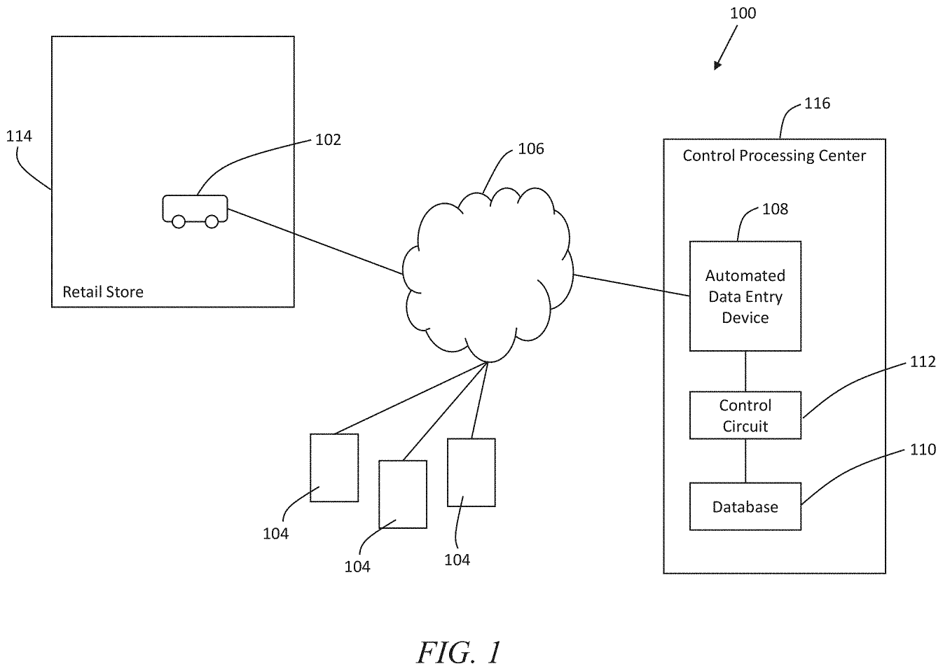

Referring now to FIG. 1, a system 100 that for determining and taking actions based upon consumer reports is described. The system 100 includes an automated vehicle 102, a plurality of user electronic devices 104, a communication network 106, an automated data entry device 108 (e.g., a smart-bot), a database 110, and a control circuit 112.

The automated vehicle 102 may be any type of automated vehicle such as an automated ground vehicle or an aerial drone. The automated vehicle is disposed in a retail store 114. The retail store 114 is any type of retail store selling any assortment of products. In other examples, the retail store 114 can be replaced with a distribution center or warehouse.

The automated vehicle 102 is configured to be able to perform various actions such as moving products. In these regards, the automated vehicle 102 may include arms, levers, and so forth for attaching to and moving products. The automated vehicle 102 may also include sensors (e.g., cameras) for sensing its surroundings. The automated vehicle 102 may be autonomous and be capable of making its own decisions without being under the control of a control center. Combinations of automated vehicles may also be used.

The plurality of user electronic devices 104 may be devices such as smartphones, cellular phones, laptops, tablets, or personal computers. Other examples of user electronic devices are possible. The user electronic devices 104 are operated by customers. Each of the user electronic devices 104 comprises an electronic interface that is configured to receive consumer reports from a customer. The electronic interface, in aspects, may be a touchscreen, keypad, display screen, or some other type of input and/or output device. Combinations of these devices may also be utilized.

The communication network 106 is any type of network (or combination of networks) such as a wireless network, cellular network, data network, or the internet. Other examples are possible. The communication network 106 is coupled to the user electronic devices 104.

The automated data entry device 108 may be a smart-bot and is disposed at a central processing center 116. The automated data entry device 108 is configured to receive and automatically discern the customer reports from the user electronic devices 104 using natural language processing approaches. The received reports are automatically tagged by the automated data entry device 108 with issue categories selected from an issue category list. In these regards, the automated data entry device 108 can identify known categories that most closely relate to incoming reports (e.g., using the natural language processing). The automated data entry device 108 is configured to web-scrape a plurality of web sites via the communication network 106 to collect issue categories from the web sites, and add to or adjust to the issue category list based upon the obtained web-scraped issue categories. In aspects, the web-scraping is accomplished by accessing the websites using the network 106 and copying information from these websites.

The automated data entry device 108 is configured to utilize the natural language processing approaches to determine when the consumer reports are missing information, and when the consumer reports are missing information, responsively transmit a first electronic message to one of the user electronic devices for rendering at the electronic interface of the user electronic device 104. The first electronic message requests the consumer enter the missing information into the first electronic interface. In these regards, the automated data entry device 108 may include a control circuit or some processing device (e.g., a microprocessor) that executes computer instructions to perform the natural language processing. In aspects, natural language processing approaches parse incoming human language input (e.g., in form of voice or text) into shorter, more elemental portions and then attempts to understand relationships between the portions and create a meaning to the portions and thereby the language input.

The database 110 is any type of memory storage device and is disposed at the central processing center 116. The database 110 stores the issue category list.

The control circuit 112 is coupled to the data entry device and the database and is disposed at the central processing center. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 112 may be configured (for example, by using corresponding programming stored in a memory as will be well understood by those skilled in the art) to carry out one or more of the steps, actions, and/or functions described herein.

The control circuit 112 is configured to determine a plurality of topic sentences and the frequency of the topic sentences from the received reports. The control circuit 112 is additionally configured to construct a master matrix and store the master matrix in the database 110. The master matrix comprises a plurality of rows with each row including one of the topic sentences and the frequency of the topic sentence.

For each of a plurality of values of k, a separate k-grouping matrix is created from the master matrix by the control circuit 112. Each k-grouping matrix arranges the topic sentences into k groupings based upon the similarity of words as between different topic sentences. Each of the k-grouping matrices is created at least in part by moving or rearranging some of the rows of the master matrix.

The k-grouping matrix having the highest value of k that does not include duplicate topic sentences is selected by the control circuit 112. From the selected k-grouping matrix, the control circuit selects the most frequent topic sentences from each of the k groupings within the k-grouping matrix.

The control circuit 112 maps each of the selected most frequent k topic sentences to one of the issue categories. Based upon each mapped issue category, the control circuit 112 automatically determines one or more actions to be undertaken at the retail store, by communications with the customer, or in the supply chain. For example, the control circuit 112 may determine that a large number of complaints has been made, and may also identify the source of the complaints. The control circuit 112 may be programmed to cause predetermined actions to occur based upon an analysis is of the most frequent issue categories, or whether certain issues occur more than a predetermined number of times to mention two examples.

The action is performed by the automated vehicle 102 or the automated data entry device 108. In examples, the action is one or more of transmitting a second electronic message to one of the electronic devices 104, moving a product to the store or within the store, or moving the product through the supply chain. Other actions include emailing store or supply chain managers with information identifying an issue and suggesting remedies to solve issues or problems.

In aspects, the control circuit 112 automatically cleans the reports after the reports are received from customers. Various approaches can be used to remove duplicate entries or correct typographical errors to mention two examples.

In examples, the issue category is a complaint, an inquiry, or an observation. Other examples are possible.

In other aspects, the web sites that are web-scraped include consumer survey reports. For example, the web sites may include text, graphs, or other presentation mechanism that presents surveys (with issue topics) and/or the results of the surveys (which may show the topics or topics of interest to consumers).

In other examples, consumers may have rated the product (e.g., by using a start rating system). These approaches may web-scrape to obtain the data, accumulate the data, and then analyze the data. In this specific example, the approaches may accumulate the concerns of multiple users from multiple web sites or web pages to obtain the most prevalent concerns for the product. These concerns may be flagged as potential issues. The web sites may include other information as well. The web-scraping may be performed across a single or multiple web sites or web pages.

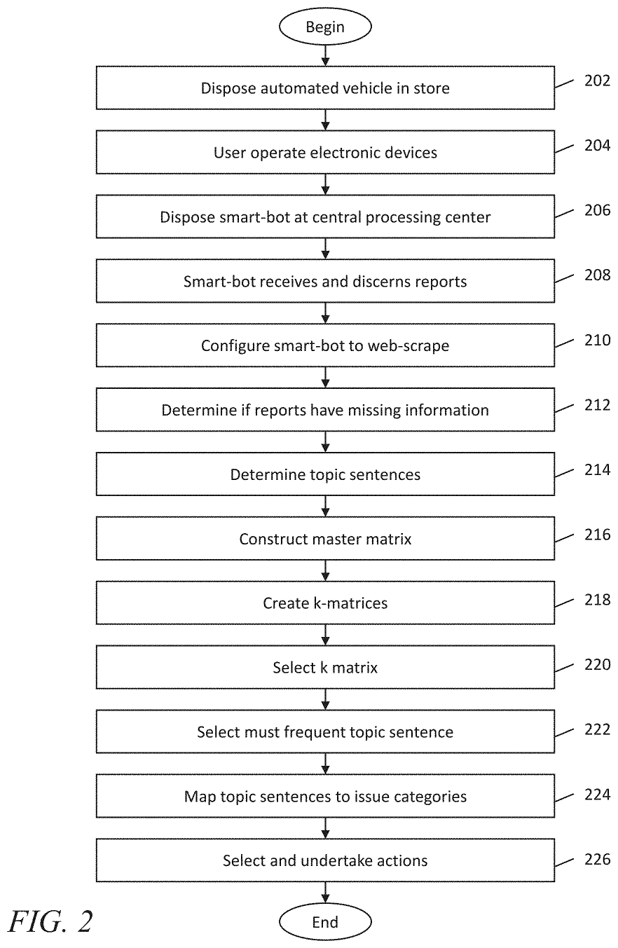

Referring now to FIG. 2, one example of an approach for processing customer reports is described.

At step 202, an automated vehicle is disposed in a retail store. The automated vehicle is, in aspects, an autonomous vehicle (that makes its own control decisions) such as an aerial drone or an automated ground vehicle.

At step 204, a plurality of user electronic devices are operated by customers. Each of the user electronic devices comprises an electronic interface that is configured to receive consumer reports from a customer. For example, the user electronic devices may be smartphones, lap tops, or tablets that include touchscreens, keypads, and/or a computer mouse.

At step 206, a smart-bot is disposed at a central processing center. The smart-bot may be an automated data entry device that receives consumer reports. The reports may be in the form of speech or data (e.g., emails or text messages). In some example, the smart-bot may be replaced by or augmented by a human operator. In some examples, the central processing center is a central call center and may be located at any geographic location.

At step 208, the smart-bot receives and automatically discerns the customer reports from the user electronic devices using natural language processing approaches. The received reports are automatically tagged by the smart-bot with issue categories selected from an issue category list. The discernment and processing may occur using natural language processing approaches or artificial intelligence (AI) processing approaches as known to those skilled in the art.

At step 210, the smart-bot is configured to web-scrape a plurality of web sites via an electronic communication network to collect issue categories from the web sites, and add to or adjust to the issue category list based upon the obtained web-scraped issue categories. The web-scraping may involve accessing web sites using one or more communication networks (e.g., the internet), obtaining information, identifying relevant information from the web sites, discerning this information, and determining whether to add this to the category list.

At step 212, the natural language processing approaches are utilized at the smart-bot to determine when the consumer reports are missing information. When the consumer reports are missing information, a first electronic message is responsively transmitted to one of the user electronic devices for rendering at the electronic interface of the user electronic device. The first electronic message requests the consumer enter the missing information into the first electronic interface.

At step 214 at a control circuit disposed at the central processing center, a plurality of topic sentences and the frequency of the topic sentences from the received reports are determined. As mentioned, the reports may be received as voice or data (e.g., text message or emails).

At step 216 and at the control circuit, a master matrix is constructed, and the master matrix is stored in the database. The master matrix comprises a plurality of rows with each row including one of the topic sentences and the frequency of the topic sentence.

At step 218 and at the control circuit and for each of a plurality of values of k, a separate k-grouping matrix is created from the master matrix. Each k-grouping matrix arranges the topic sentences into k groupings based upon the similarity of words as between different topic sentences. Each of the k-grouping matrices is created at least in part by moving or rearranging some of the rows of the master matrix.

At step 220 and at the control circuit, the k-grouping matrix having the highest value of k that does not include duplicate topic sentences is selected.

At step 222 and at the control circuit and from the selected k-grouping matrix, the most frequent topic sentences from each of the k groupings within the k-grouping matrix are selected.

At step 224 and at the control circuit, each of the selected most frequent k topic sentences is mapped to one of the issue categories.

At step 226 and at the control circuit, based upon each mapped issue category one or more actions to be undertaken at the retail store, by communications with the customer, or in the supply chain are automatically determined. The action is performed by the automated vehicle or the smart-bot. In aspects, the action is one or more of transmitting a second electronic message to one of the electronic devices, moving a product to the store or within the store, or moving the product through the supply chain. Other examples are possible.

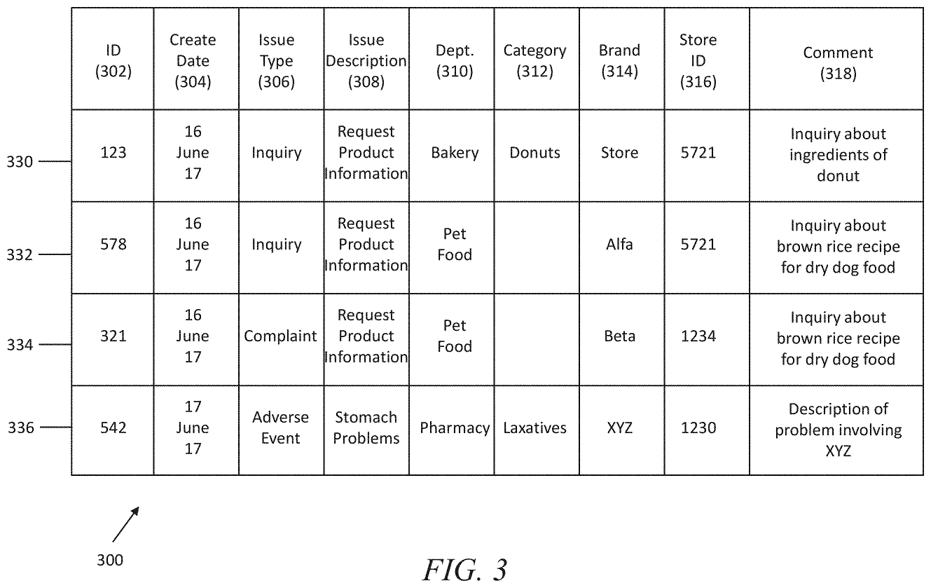

FIG. 3 shows a master matrix or table 300 constructed from data that has been received from customers (e.g., via voice messages or text messages). Data cleaning may take place, for example, to remove typographical errors from the received information. Columns in the matrix indicate an identification number for the entry (302), the date the entry was received or created (304), the issue type (306) (e.g., inquiry, complaint, or adverse event), an issue description (308) (e.g., requested product information or stomach problems), the department associated with the product (310), the product category (312), the brand or manufacturer of the product (314), the store identification of the store from which the product was purchase (316), and any additional comments (318) associated with the report. Additional types of information may also be included.

The master matrix 300 includes rows 330, 332, 334, and 336. Each of the rows 330, 332, 334, and 336 is associated with a single customer report. Not every entry in each row need be filled. For example, some information from some customer reports may be unknown because the customer does not provide that information. For simplicity, the matrix 300 is shown will only four entries. However, it will be appreciated that the table may have many other entries (e.g., in the thousands, tens of thousands, or even millions).

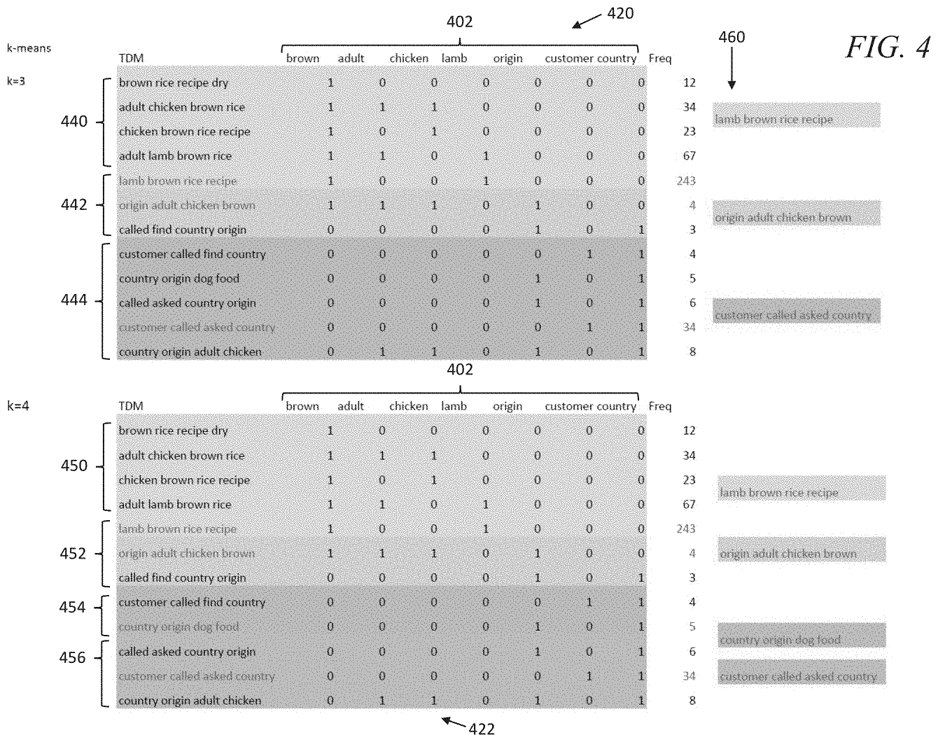

After the master matrix 300 is created, separate other tables are created for values of k (with k being an integer) from the master matrix 300. Referring now to FIG. 4, each entry (or sentence) in each of the k tables is a 4-word phrase (4-gram) taken from entries in the matrix 300. The frequency of these sentences is counted. For example, “brown rice recipe dry” has occurred 12 times in the matrix 300.

Key words 402 for all phrases in the matrix are then determined. In this example, the key words include “brown,” “adult,” “chicken,” “lamb,” “origin,” “customer,” and “country.” The determination or selection of key words may be based upon a human (manual) review (or decision) or may be made automatically. Next, the number of occurrences of the word in each phrase (row of the matrix) or whether the word occurs in the phrase are determined. This information is included in the columns in the matrix in the row associated with the phrase. In this example, “Brown” has 1 occurrence (or occurs in the phrase), and the remainder of the key words are not present.

Next, k-analysis is performed. The master matrix (e.g., matrix 300) is separated (or copied) into a different k-grouping matrix for each value of k. In this example, two values of k (k=3 and k=4) are used. This creates a first k-grouping matrix 420 (for k=3) and a second k-grouping matrix 422 (for k=4). It will be appreciated that any number of values for k may be selected.

Each of the k-grouping matrices 420 and 422 divide the entries into k groups. The matrix 420 will be divided into 3 groups 440, 442, 442 (because k=3 for this matrix) while the matrix 422 is divided into 4 groups 450, 452, 454, 456 (since k=4 for this matrix). The groups are chosen by the closeness of the keywords in each group to the keywords in others of the groups. For example, member of the grouping 440 share all or some of the keywords “brown,” “rice,” and/or “chicken.” It will be appreciated that the k-grouping matrices need not be separated into separate files. Additionally, it will be understood that only two k-grouping matrices are shown for simplicity. Any number of k-grouping matrices are possible.

Each groups (440, 442, 446) or (450, 452, 454, 456) has a most frequent sentence 460. For example, the group 440 has the most frequent sentence of “lamb brown rice recipe.”

Then, the process look for duplicates in each of the groups (440, 442, 446) and (450, 452, 454, 456). The group of topic sentences with the highest k number that had no duplicates is selected. In this case (assuming only k=3 and k=4), there are no duplicates in matrix 422, so the most frequent topic sentences for this matrix with k=4 are selected. Each of these most frequent topic sentences can be correlated with subject matter tag (e.g., entered by the operator or automatically entered when the sentence was received). These can be further analyzed to determine the taking of an appropriate action.

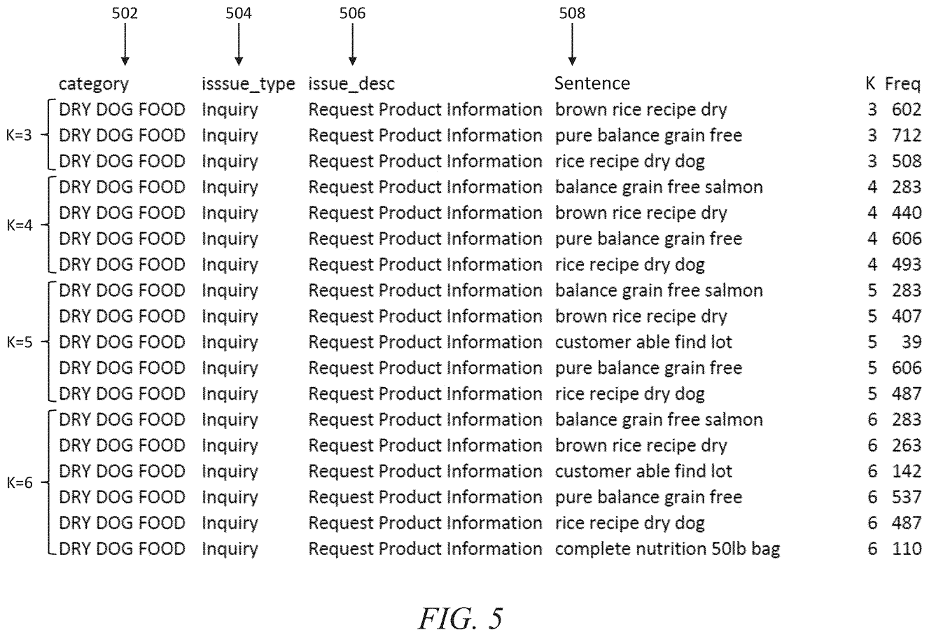

As shown in FIG. 5, the output of the process of FIG. 4 may be a listing of the most frequent sentences for each value of k (one sentence in each row of a table 500) including for each sentence a product category 502 of the sentence, an issues type 504 of the sentence, an issue description 506 of the sentence, correlated back to topic sentences 508 and including frequencies.

In this case, assuming no duplicates in the k=6 groupings, the most frequent topic sentences for k=6 are selected. In one example, this information can be displayed to a user. Once the viewer examines the information actions can be taken.

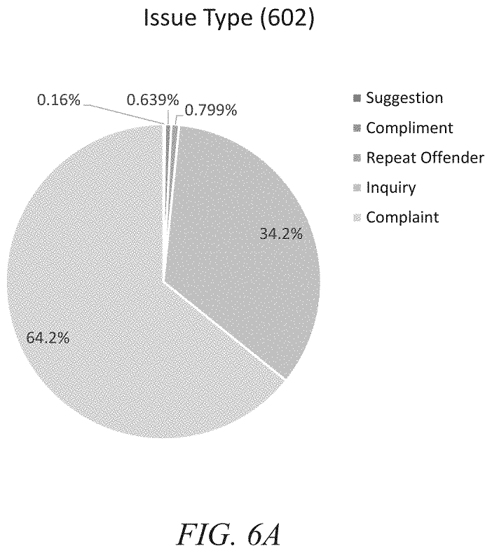

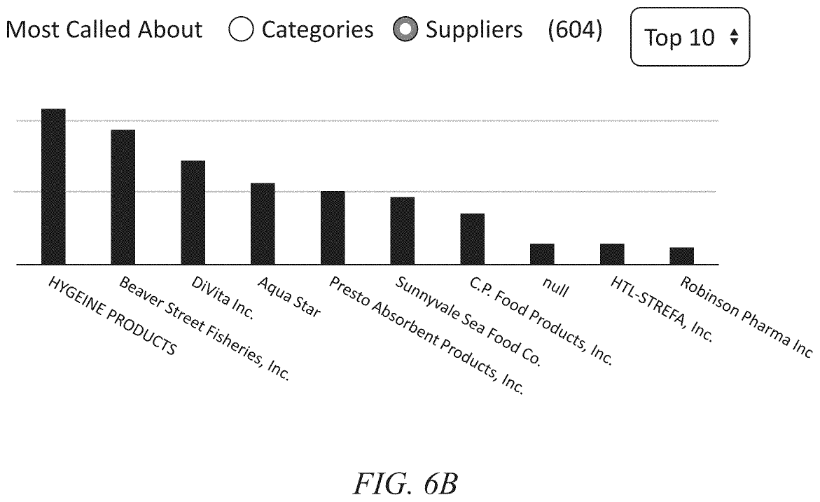

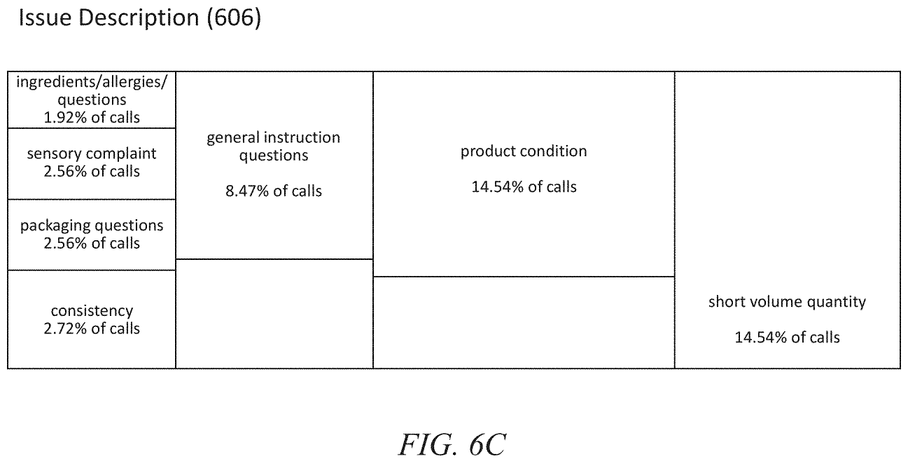

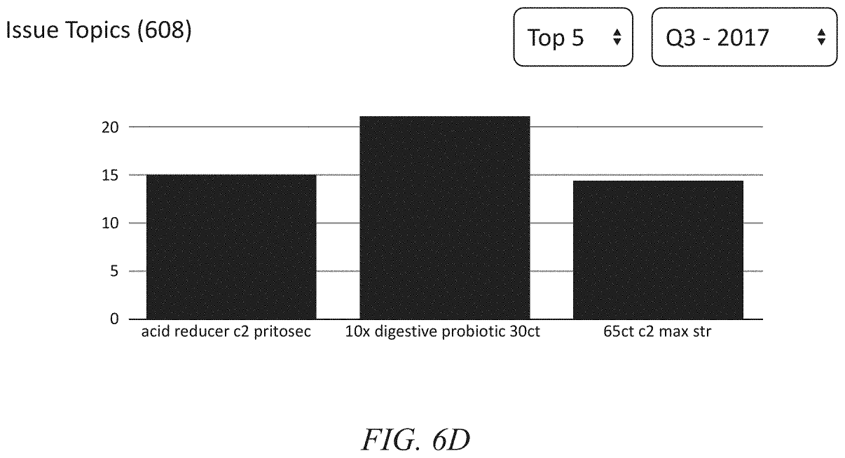

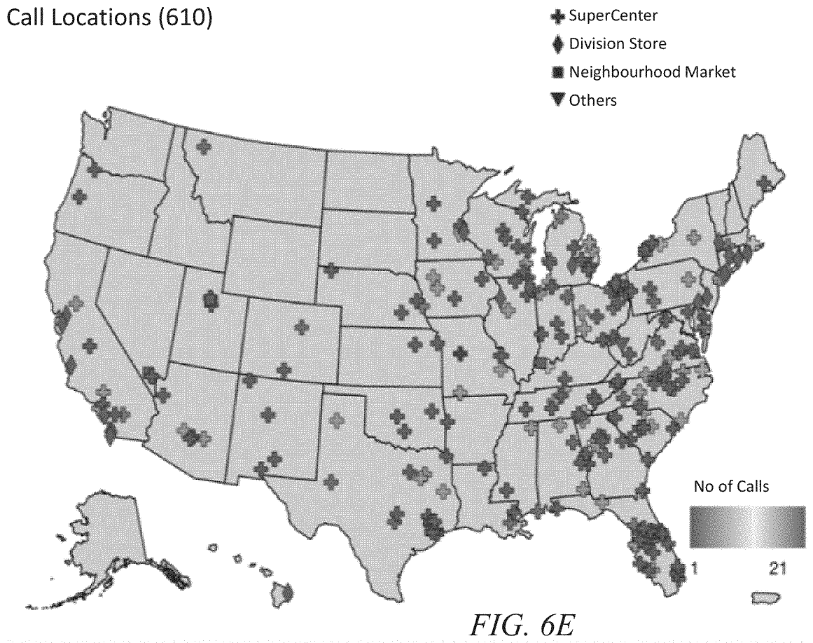

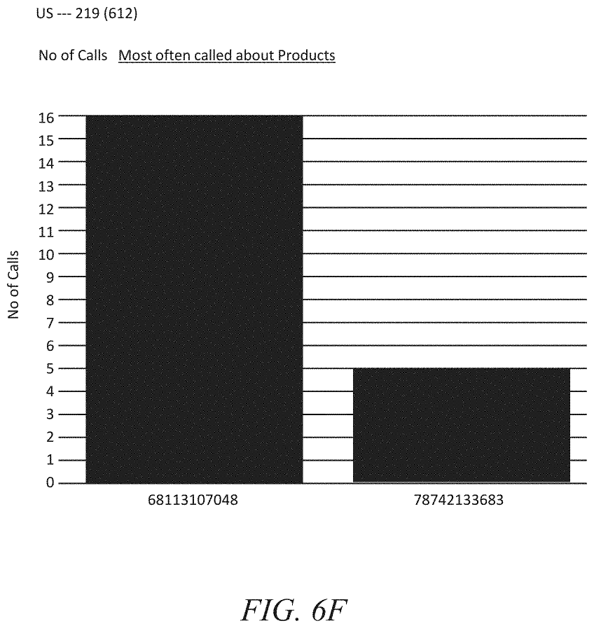

FIGS. 6A-F show a sample display and are meant to be positioned on the same screen. The information may be displayed as an issue type 602, most called about categories 604, issue descriptions 606, issue topics 608, a geographic map 610 showing originating locations of customer reports, and the number of calls for the most called about products 612.

It will be appreciated that the example of FIGS. 6A-F is one example of displaying information obtained by the approaches herein and that other examples are possible.

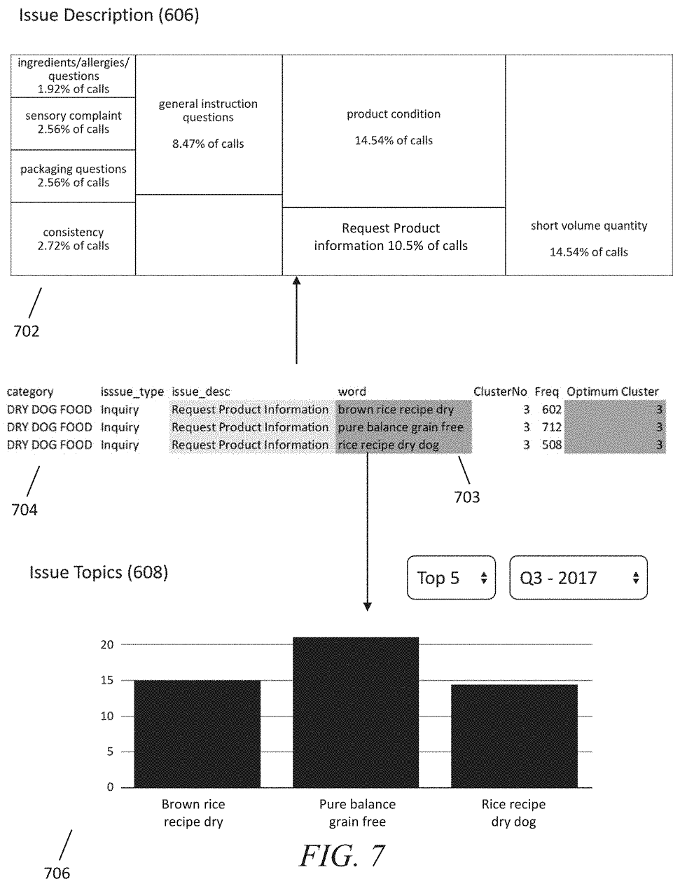

Referring now to FIG. 7, in aspects, users can click (e.g., using a computer mouse) or using a touch screen to select various portions of the display of FIG. 6 to select/expand fields (“drill down”) and obtain further information. For example, selecting a portion of the issue description field 606 at step 702 obtains information 704. A portion 703 of the information 704 can be selected and the graph 706 obtained.

It will be appreciated that the example of FIG. 7 is one example of drilling down and that other examples are possible.

In some embodiments, one or more of the exemplary embodiments include one or more localized IoT devices and controllers. As a result, in an exemplary embodiment, the localized IoT devices and controllers can perform most, if not all, of the computational load and associated monitoring and then later asynchronous uploading of data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of data may include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernals of data in order to filter out data that may reflect generic background data. In an exemplary embodiment, KRG incrementally sequences all future undefined cached kernals having encoded asynchronous data in order to filter out data that may reflect generic background data. In a further exemplary embodiment, the kernel will filter out noisy data (“KRN”). In an exemplary embodiment, KRN, like KRI, includes substantially a continuously utilized near term source of data, but KRN may be retained in order to provide a predictive model of noisy data. In an exemplary embodiment, KRN and KRI, also incrementally sequences all future undefined cached kernels having encoded asynchronous data in order to filter out data that may reflect generic background data.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system that is configured to determine and take actions based upon consumer reports, the system comprising:
an automated vehicle that is disposed in a retail store;
a plurality of user electronic devices operated by customers, wherein each of the user electronic devices comprises an electronic interface that is configured to receive consumer reports from a customer;
a communication network coupled to the user electronic devices;
a smart-bot disposed at a central processing center, the smart-bot being configured to receive and automatically discern the customer reports from the user electronic devices using natural language processing approaches, the received reports being automatically tagged by the smart-bot with issue categories selected from an issue category list, the smart-bot being configured to web-scrape a plurality of web sites via the communication network to collect issue categories from the web sites, and add to or adjust to the issue category list based upon the obtained web-scraped issue categories;
wherein the smart-bot is configured to utilize the natural language processing approaches to determine when the consumer reports are missing information, and when the consumer reports are missing information, responsively transmit a first electronic message to one of the user electronic devices for rendering at the electronic interface of the user electronic device, the first electronic message requesting the consumer enter the missing information into the first electronic interface;
a database disposed at a central processing center, the database storing the issue category list;
a control circuit coupled to the data entry device and the database, the control circuit being disposed at the central processing center, the control circuit configured to:
determine a plurality of topic sentences and the frequency of the topic sentences from the received reports;
construct a master matrix and store the master matrix in the database, the master matrix comprising a plurality of rows with each row including one of the topic sentences and the frequency of the topic sentence;
for each of a plurality of values of k create a separate k-grouping matrix from the master matrix, each k-grouping matrix arranging the topic sentences into k groupings based upon the similarity of words as between different topic sentences, wherein each of the k-grouping matrices is created at least in part by moving or rearranging some of the rows of the master matrix;
select the k-grouping matrix having the highest value of k that does not include duplicate topic sentences;
from the selected k-grouping matrix, select the most frequent topic sentences from each of the k groupings within the k-grouping matrix;
map each of the selected most frequent k topic sentences to one of the issue categories;
based upon each mapped issue category, automatically determine one or more actions to be undertaken at the retail store, by communications with the customer, or in the supply chain;
wherein the action is performed by the automated vehicle or the smart-bot, the action being one or more of transmitting a second electronic message to one of the electronic devices, moving a product to the store or within the store, or moving the product through the supply chain.

2. The system of claim 1, wherein the control circuit automatically cleans the reports.

3. The system of claim 1, wherein the user device comprises a smartphone, a laptop, a tablet, or a personal computer.

4. The system of claim 1, wherein the issue category is a complaint, an inquiry, or an observation.

5. The system of claim 1, wherein the automated vehicle is a drone or automated ground vehicle.

6. The system of claim 1, wherein the web sites include consumer survey reports.

7. The system of claim 1, wherein the web-scraping is performed across multiple web sites.

8. A method for determining and taking actions based upon consumer reports, the method comprising:
disposing an automated vehicle in a retail store;
operating a plurality of user electronic devices by customers, wherein each of the user electronic devices comprises an electronic interface that is configured to receive consumer reports from a customer;
disposing a smart-bot at a central processing center, the smart-bot being configured to receive and automatically discern the customer reports from the user electronic devices using natural language processing approaches, the received reports being automatically tagged by the smart-bot with issue categories selected from an issue category list, the smart-bot being configured to web-scrape a plurality of web sites via an electronic communication network to collect issue categories from the web sites, and add to or adjust to the issue category list based upon the obtained web-scraped issue categories;
utilizing the natural language processing approaches at the smart-bot to determine when the consumer reports are missing information, and when the consumer reports are missing information, responsively transmitting a first electronic message to one of the user electronic devices for rendering at the electronic interface of the user electronic device, the first electronic message requesting the consumer enter the missing information into the first electronic interface;
storing the issue category list at a database;
at a control circuit at the central processing center, determining a plurality of topic sentences and the frequency of the topic sentences from the received reports;
at the control circuit, constructing a master matrix and store the master matrix in the database, the master matrix comprising a plurality of rows with each row including one of the topic sentences and the frequency of the topic sentence;
at the control circuit and for each of a plurality of values of k, creating a separate k-grouping matrix from the master matrix, each k-grouping matrix arranging the topic sentences into k groupings based upon the similarity of words as between different topic sentences, wherein each of the k-grouping matrices is created at least in part by moving or rearranging some of the rows of the master matrix;
at the control circuit, selecting the k-grouping matrix having the highest value of k that does not include duplicate topic sentences;
at the control circuit and from the selected k-grouping matrix, selecting the most frequent topic sentences from each of the k groupings within the k-grouping matrix;
at the control circuit, mapping each of the selected most frequent k topic sentences to one of the issue categories;
at the control circuit and based upon each mapped issue category, automatically determining one or more actions to be undertaken at the retail store, by communications with the customer, or in the supply chain;
wherein the action is performed by the automated vehicle or the smart-bot, the action being one or more of transmitting a second electronic message to one of the electronic devices, moving a product to the store or within the store, or moving the product through the supply chain.

9. The method of claim 8, wherein the control circuit automatically cleans the reports.

10. The method of claim 8, wherein the user device comprises a smartphone, a laptop, a tablet, or a personal computer.

11. The method of claim 8, wherein the issue category is a complaint, an inquiry, or an observation.

12. The method of claim 8, wherein the automated vehicle is a drone or automated ground vehicle.

13. The method of claim 8, wherein the web sites include consumer survey reports.

14. The method of claim 8, wherein the web-scraping is performed across multiple web sites.
